(19) United States
(12) Patent Application Publication
(10) Pub. No.: US 2019/0120431 A1
(43) Pub. Date: Apr. 25, 2019

(54) REAL TIME ANALYSIS LOGGING OF VARIOUS GASES AND CONTAMINANTS FOR SPECIFIC BREATHING AIR CYLINDERS

(71) Applicant: SCOTT TECHNOLOGIES, INC., Monroe, NC (US)

(72) Inventors: Marvin Carroll, Greensboro, NC (US); Joshua Nathaniel Burnheimer, Charlotte, NC (US)

(21) Appl. No.: 16/093,748

(22) PCT Filed: Apr. 17, 2017
(86) PCT No.: PCT/US17/27926

§ 371 Date: Oct. 15, 2018

Related U.S. Application Data
(60) Provisional application No. 62/322,986, filed on Apr. 15, 2016.

(51) Int. Cl. F17C 5/00; F17C 13/02

(52) U.S. Cl. CPC F17C 5/00; F17C 13/02; F17C 2205/058; F17C 2250/0447; F17C 2250/036; F17C 2205/057; F17C 2250/032; F17C 2221/031; F17C 2250/034; F17C 2250/043

(57) ABSTRACT

An apparatus for transferring gas to a gas vessel is provided. The apparatus includes a radio frequency identification (RFID) reader configured to interrogate an RFID tag associated with the gas vessel for RFID information. The apparatus includes a gas input port configured to be in removably connected to gas supply, a gas output port configured to be removably connected to the gas vessel and a processor configured to: determine at least one gas vessel characteristic associated with the RFID information, control a flow of gas from the gas input port to the gas output port based at least in part on the at least one gas vessel characteristic, determine at least one filling criterion based at least in part on the RFID information, determine whether the at least one filling criterion is met, and trigger at least one action if the at least one filling criterion is not met.

### TECHNICAL FIELD

The present invention relates to filling a gas vessel, and in particular to a method and apparatus for controlling the filling of a gas cylinder.

### BACKGROUND

Gas cylinders are used in a variety of tasks such as scuba diving, firefighting, etc., in which various conditions should be met to properly and safely fill gas cylinders with gas. One primary concern is the quality of the fill gas entering the cylinder. For example, “dirty air” or contaminated air contained in the gas cylinder can be deadly to the user. Standards bodies, such as the National Fire Protection Association (NFPA), the National Institute for Occupational Safety and Health (NIOSH), and the Occupational Safety and Health Administration (OSHA), have set standards for the limits of various contaminants and particulates in compressed breathing air.

### SUMMARY

The present invention advantageously provides a method and system for controlling the filling of a gas cylinder with gas.

According to one aspect of the invention, an apparatus for transferring gas to a gas vessel is provided. The apparatus includes a radio frequency identification (RFID) reader configured to interrogate an RFID tag associated with the gas vessel for RFID information. The apparatus includes a gas input port configured to be in removably connected to gas supply, a gas output port configured to be removably connected to the gas vessel and a processor configured to: determine at least one gas vessel characteristic associated with the RFID information, control a flow of gas from the gas input port to the gas output port based at least in part on the at least one gas vessel characteristic, determine at least one filling criterion based at least in part on the RFID information, determine whether the at least one filling criterion is met, and trigger at least one action if the at least one filling criterion is not met.

According to one embodiment of this aspect, the processor is configured to perform at least one sample of the gas at the gas output port. The determination whether the at least one filling criterion is met includes determining whether the at least one sample meets the at least one filling criterion.

According to one embodiment of this aspect, the at least one gas vessel characteristic includes at least one of a serial number of the gas vessel, operating pressure of the gas vessel, hydrostatic test date of the gas vessel, manufactured date of the gas vessel, type of gas vessel, frequency of usage of the gas vessel and a gas composition. According to one embodiment of this aspect, the at least one gas vessel characteristic includes a composition of gas that the gas vessel is allowed to accept. According to one embodiment of this aspect, the at least one gas vessel characteristic includes a composition of gas the gas vessel is not allowed to accept. According to one embodiment of this aspect, the at least one filling criterion includes a threshold value for at least one particulate. The at least one action that is triggered if the at least one sample does not meet the at least one filling criteria, includes: at least temporarily stopping the flow of gas from the gas input port to the gas output port, and causing the RFID reader to write data to the RFID tag of the gas vessel, the data written to the RFID tag indicating the at least one filling criterion is not met.

According to one embodiment of this aspect, the at least one sample is performed during the filling of the gas vessel. According to one embodiment of this aspect, the at least one sample includes a sample of the gas contained in the gas vessel. According to one embodiment of this aspect, the at least one filling criterion includes at least one of: time remaining to a predefined end life date of the gas vessel, time from a previous hydrostatic test date of the gas vessel and a predefined number of refills of the gas vessel. The at least one action that is triggered includes: preventing the flow of gas from the gas input port to the gas output port, and causing the RFID reader to write data to the RFID tag of the gas vessel, the data written to the RFID tag indicating the at least one filling criterion is not met.

According to one embodiment of this aspect, the processor is further configured to: determine a first pressure of gas vessel before initiating flow of gas from the gas input port to the gas output port, determine a second pressure of the gas vessel after the flow of gas from the gas input port to the gas output port has been stopped, and cause the RFID reader to write the first pressure and the second pressure of the gas vessel to the RFID tag. According to one embodiment of this aspect, the at least one action includes generating at least one of an audio and visual alert. According to one embodiment of this aspect, the at least one filling criterion includes whether an operating pressure level of the gas vessel equals a fill pressure level of the apparatus. The at least one action that is triggered includes triggering at least one of an audio warning and visual warning.

According to another aspect of the invention, a method for an apparatus for transferring gas to a gas vessel is provided. The apparatus includes a gas input port configured to be removably connected to a gas supply, and a gas output port configured to be removably connected to the gas vessel. An RFID tag associated with the gas vessel is interrogated for RFID information. At least one gas vessel characteristic associated with the RFID information is determined. A flow of gas from the gas input port to the gas output port is controlled based at least in part on the at least one gas vessel characteristic. At least one filling criterion is determined based at least in part on the RFID information. A determination is made whether the at least one filling criterion is met. At least one action is triggered if the at least one filling criterion is not met.

According to one embodiment of this aspect, at least one sample of the gas is performed at the gas output port. The determination whether the at least one filling criterion is met includes determining whether the at least one sample meets the at least one filling criterion. According to one embodiment of this aspect, the at least one gas vessel characteristic includes at least one of a serial number of the gas vessel, operating pressure of the gas vessel, hydrostatic test date of the gas vessel, manufactured date of the gas vessel, type of gas vessel, frequency of usage of the gas vessel and a gas composition. According to one embodiment of this aspect, the at least one gas vessel characteristic includes a composition of gas that the gas vessel is allowed to accept.

According to one embodiment of this aspect, the at least one gas vessel characteristic includes a composition of gas the gas vessel is not allowed to accept. According to one embodiment of this aspect, the at one filling criterion includes a threshold value for at least one particulate. The at least one action that is triggered if the at least one sample does not meet the at least one filling criteria, includes: pausing the flow of gas from the gas input port to the gas output port, and causing the RFID reader to write data to the RFID tag of the gas vessel, the data written to the RFID tag indicating the at least one filling criterion is not met.

According to one embodiment of this aspect, the at least one sample is performed during the filling of the gas vessel. According to one embodiment of this aspect, the at least one sample includes a sample of the gas contained in the gas vessel. According to one embodiment of this aspect, the at least one filling criterion includes at least one of: time remaining to a predefined end life date of the gas vessel, time from a previous hydrostatic test date of the gas vessel, and a predefined number of refills of the gas vessel. The at least one action that is triggered includes: preventing the flow of gas from the gas input port to the gas output port, and causing the RFID reader to write data to the RFID tag of the gas vessel, the data written to the RFID tag indicating the at least one filling criterion is not met.

According to one embodiment of this aspect, a first pressure of gas vessel is determined before initiating flow of gas from the gas input port to the gas output port. A second pressure of the gas vessel is determined after the flow of gas from the gas input port to the gas output port has been stopped. The RFID reader is caused to write the first pressure and the second pressure of the gas vessel to the RFID tag. According to one embodiment of this aspect, the at least one action includes generating at least one of an audio and visual alert. According to one embodiment of this aspect, the at least one filling criterion includes whether an operating pressure level of the gas vessel equaling a fill pressure level of the apparatus. The at least one action that is triggered includes triggering at least one of an audio warning and visual warning.

According to another aspect of the invention, an apparatus for transferring gas to a gas vessel is provided. The apparatus includes a radio frequency identification (RFID) module configured to cause interrogation of an RFID tag associated with the gas vessel for RFID information. The apparatus includes a gas input port configured to be in removably connected to a gas supply. The apparatus includes a gas output port configured to be removably connected to the gas vessel. The apparatus includes a processor configured to: determine at least one gas vessel characteristic associated with the RFID information, control a flow of gas from the gas input port to the gas output port based at least in part on the at least one gas vessel characteristic, determine at least one filling criterion based at least in part on the RFID information, determine whether the at least one filling criterion is met, and trigger at least one action if the at least one filling criterion is not met.

In one embodiment, a charge station is provided for filling a gas cylinder with gas. The charge station includes a gas output port configured to be fluidly connected to a supply of gas. The gas output port is configured to be fluidly connected to the gas cylinder for filling the gas cylinder with gas from the supply of gas. The charge station also includes a control system operatively connected to the gas output such that the control system is configured to control filling of the gas cylinder, and a radio frequency identification (RFID) reader operatively connected to the control system, the RFID reader configured to read data from an RFID tag on the gas cylinder.

In another embodiment, a gas cylinder filling system is provided for filling a gas cylinder with gas. The gas cylinder filling system includes a supply of gas and a charge station. The charge station includes a gas output port fluidly connected to the supply of gas. The gas output port is configured to be fluidly connected to the gas cylinder for filling the gas cylinder with gas from the supply of gas. The charge station also includes a control system operatively connected to the gas output such that the control system is configured to control filling of the gas cylinder, and a radio frequency identification (RFID) reader operatively connected to the control system, the RFID reader configured to read data from an RFID tag on the gas cylinder.

In another embodiment, a method is provided for filling a gas cylinder with gas using a charge station. The method includes reading data from a radio frequency identification (RFID) tag on the gas cylinder, and filling the gas cylinder with gas based at least in part on data read from the RFID tag on the gas cylinder.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of an exemplary embodiment of gas vessel filling system in accordance with the principles of the invention;

FIG. 2 is a perspective view of the gas vessel filling system of FIG. 1;

FIG. 3 is a perspective view of an exemplary alternative embodiment of gas vessel filling system;

FIG. 4 is a flowchart of the gas flow process of gas flow code for filling the gas vessel with gas using gas vessel filling system in accordance with the principles of the invention;

FIG. 5 is a flowchart of an alternative embodiment of gas flow process of gas flow code for filling the gas vessel with gas using gas vessel filling system in accordance with the principles of the invention; and

FIG. 6 is a block diagram of an alternative embodiment of charge station in accordance with the principles of the invention.

### DETAILED DESCRIPTION

There is a need for a gas cylinder filling system for prevention testing of air contaminants for gas cylinder filling systems. It is noted that, for purposes of this disclosure and ease of understanding, air is referred to as a gas.

The invention includes real-time testing for various contaminants and particulates in compressed breathing air. Real time analysis of the gases includes relating those measurements and data to a specific filled cylinder. This data also serves as a record for the fill to confirm whether the user had less than optimum breathing air quality. The invention further includes oil particulate measurements which can taint air within a system without causing failure or alarm with any of the common air quality measurements (CO, H2O, etc.). For example, while oil is used to lubricate the piston and other parts of the air compressor, it should be removed through the filtration cartridges, although this is not always the case.

If contaminants are determined to be present in the air that is filling the breathing air cylinder in a charge station, the RFID reader automatically reads the serial number along with other information stored on the RFID chip as it relates to that specific cylinder. As the cylinder is being filled by the compressor and charge station, one or more real-time samples of the gas is being analyzed, time stamped, and stored in a database tied to that specific breathing air cylinder being charged. This analysis preferably includes condensed oil mist and particulate, e.g., H2S, CO2, CO, O2, VOC's, nitrogen, ammonia and/or other like contaminants In some embodiments, the analysis includes contaminants of unacceptable air compositions, such as for example without limitation, unacceptable levels of O2 in the fill air, i.e., in the gas being used to fill the gas cylinder. This data is real time and tied to each cylinder filled, which is stored in a database either on the compressor/charge station controller, retained in the communication network cloud, or both. This data is accessed at any time to show exactly what particulates and gasses are in the cylinder that was filled using that compressor. The system automatically ties the real-time sample analysis to each specific cylinder filled, drastically improving safety over the quarterly air samples typically obtained for a breathing air compressor. Use of a database also allows historical analyses to track a cylinder over time.

When coupled with RFID cylinder tracking technology, this process is fully automated and does not require human intervention to record the data. This streamlines the filling and tracking process and ensures the data is tamper resistant.

Before describing in detail exemplary embodiments, it is noted that the embodiments reside primarily in combinations of apparatus components and processing steps related to filling gas vessels using real time analysis of one or more samples of various gases and contaminants. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

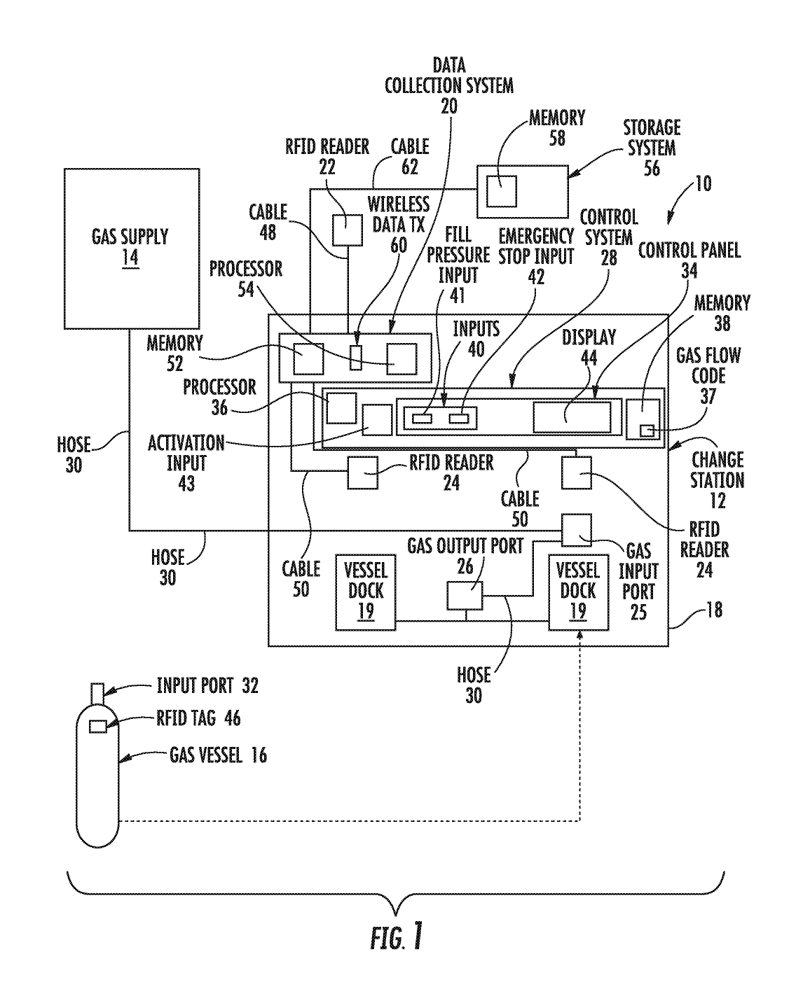

FIG. 1 is a block diagram of an exemplary embodiment of gas vessel filling system 10 in accordance with the principles of the invention. In one or more embodiments, while the term “gas” is used herein, system 10 is applicable to in accordance with the principles of the invention. In one or more embodiments, a gas vessel is a gas cylinder or other vessel capable of storing gas above atmospheric pressure. System 10 includes charge station 12 and gas supply 14. As will be described below, charge station 12 is configured to fill gas vessel 16 with a gas. In one or more embodiments, the fluid may be any gas, such as, but not limited to, a breathing gas (such as, but not limited to, air, oxygen, nitrox, tirmix, heliox, heliair, hydreliox, hydrox, neox, and/or the like) and/or the like. Gas vessel 16 may be any type of gas vessel, such as, but not limited to, a gas cylinder for a self-contained breathing apparatus (SCBA), a space suit, medical equipment, a self-contained underwater breathing apparatus (SCUBA), and/or the like. Although shown as generally cylindrical in shape, in addition or alternatively to the cylindrical shape, gas vessel 16 may include any other shape(s).

Charge station 12 includes housing 18, data collection system 20, one or more radio frequency identification (RFID) readers 22, one or more RFID readers 24, one or more gas input ports 25, one or more gas output ports 26, and control system 28. In one or more embodiments, gas input port 25 is configured to be removably connected to gas supply 14. In one or more embodiments, gas output port 26 is configured to be removably connected to gas vessel 16. Housing 18 includes one or more vessel docks 19 that receive the gas vessel 16. Each gas output port 26 extends adjacent a corresponding one of the vessel docks 19 and is fluidly connected to the gas supply 14, for example via gas input port 25 and one or more hoses 30.

Each gas output port 26 is configured to be fluidly connected to input port 32 of gas vessel 16 for filling gas vessel 16 with gas from gas supply 14. Specifically, when gas vessel 16 is desired to be filled, gas vessel 16 is mounted on vessel dock 19 and input port 32 of gas vessel 16 is fluidly connected to gas output port 26. Although one gas output port 26, one gas input port 25 and two vessel docks 19 are shown in FIG. 1, charge station 12 may include any number of gas output ports 26, gas input ports 25 and any number of vessel docks 19, for example for simultaneously filling any number of gas vessels 16. In one or more embodiments, gas supply 14 is not a component of charge station 12. For example, in one or more embodiments, gas supply 14 is not held by housing 18 of charge station 12. Alternatively, gas supply 14 is a component of charge station 12.

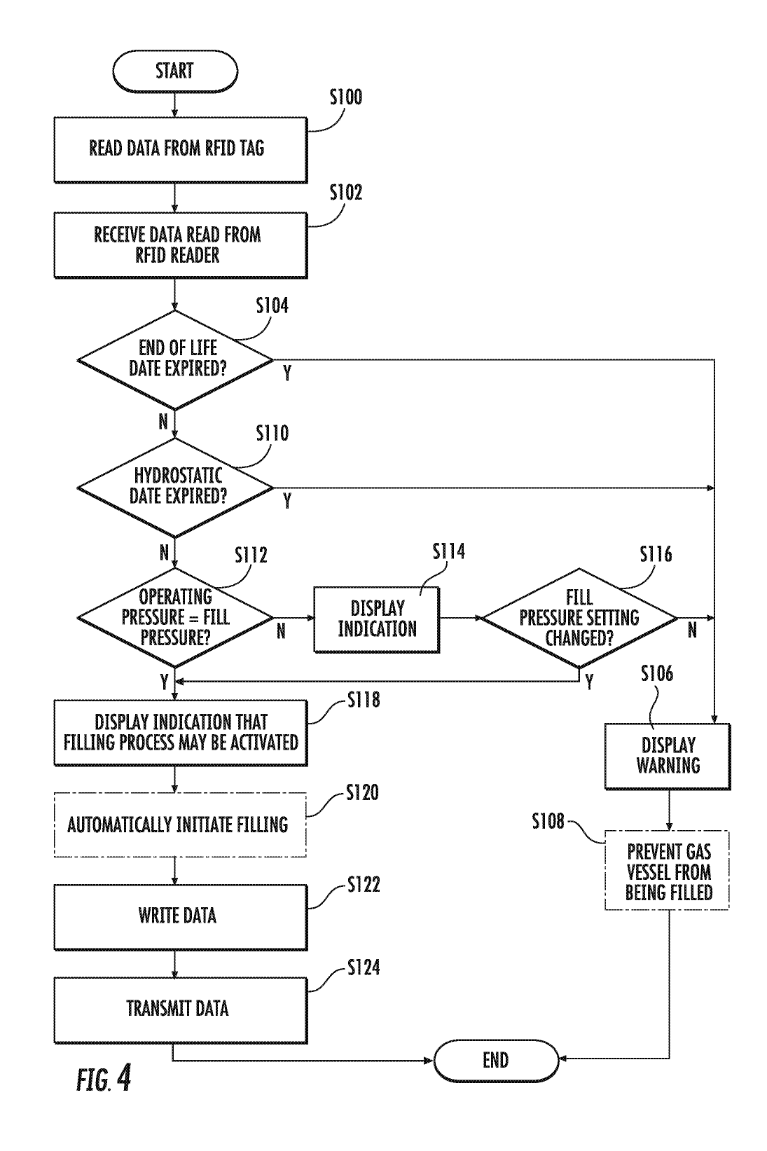

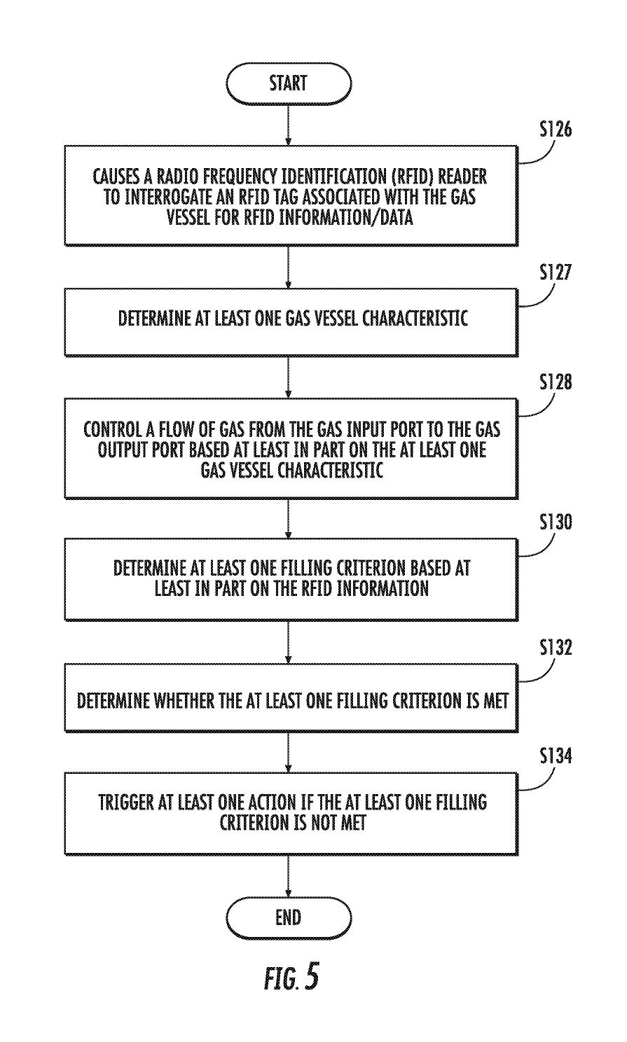

Control system 28 controls filling of gas vessel 16 with gas from gas supply 14. In one or more embodiments, control system 28 includes control panel 34, one or more processors 36, and memory 38. In one or more embodiments, memory 38 is configured to store gas flow code 37 for controlling the filling of gas vessel 16 with gas from gas supply 14, as described in detail with respect to FIGS. 4-5. In one or more embodiments, processor 36 automatically controls some or all portions of the filling process, such as, but not limited to, activating the filling process, deactivating the filling process, selecting parameters of the filling process (such as, but not limited to, selecting a pressure to fill gas vessel 16 with and/or the like), and/or the like, such as the processes described in detail with respect to FIGS. 4-5.

Control system 28 includes activation input 43 that enables an operator to manually start filling gas vessel 16 with gas. In one or more embodiments, activation input 43 is remote from control panel 34. Alternatively, in one or more embodiments, control panel 34 includes activation input 43. In one or more embodiments, control panel 34 includes inputs 40 that enable an operator to manually control some or all of the filling process, such as, but not limited to, activating the filling process, deactivating the filling process, selecting parameters of the filling process (such as, but not limited to, selecting a pressure to fill gas vessel 16 with, gas vessel characteristics and/or the like), and/or the like. In the exemplary embodiment, control panel 34 includes fill pressure input 41 and emergency stop input 42. Fill pressure input 41 enables an operator to manually select the pressure to fill gas vessel 16 with from a range of fill pressures. Emergency stop input 42 enables an operator to stop filling gas vessel 16 with gas. Control panel 34 optionally includes display 44 for displaying, such as, but not limited to, warnings, indications, parameters of the filling process, and/or the like, some of which are described herein.

RFID readers 22 and 24 are each configured to read data from one or more RFID tags 46 affixed, attached and/or associated with gas vessel 16. RFID reader 22 is a hand-held RFID reader. RFID reader 24 is fixedly mounted on housing 18 of charge station 12. In the exemplary embodiment, RFID readers 22 and 24 are each operatively connected to data collection system 20 using respective electrical cable 48 and 50. However, in one or more embodiments, RFID readers 22 and 24 each are connected to data collection system 20 using any suitable means, such as, but not limited to, using a wireless transmitter (not shown).

In one or more embodiments, data collection system 20 is operatively connected to control system 28 for automatically controlling some or all portions of the filling process, such as, but not limited to, activating the filling process, deactivating the filling process, selecting parameters of the filling process (such as, but not limited to, selecting a pressure to fill gas vessel 16 with and/or the like), and/or the like. In one or more embodiments, data collection system 20 includes one or more memories 52 configured to store data, such as, but not limited to, logging information from the gas flow process described herein, data read from RFID tag 46 by RFID reader 22 and/or 24, data related to gas vessel 16, data related to the gas vessel filling system 10 (including data related to charge station 12), processor executable instructions such as gas flow code 37 and/or the like. The data read from RFID tag 46 by RFID reader 22 and/or 24, the data related to gas vessel 16, and the data related to gas vessel filling system 10 (including data related to charge station 12) may include or indicate one or more gas vessel characteristic such as, but is not limited to, a serial number of gas vessel 16, an operating pressure of gas vessel 16, a hydrostatic test date of gas vessel 16, a manufactured date of gas vessel 16, a type of gas vessel 16, fluid composition, an end of life date of gas vessel 16, an early warning of upcoming cylinder obsolescence of gas vessel 16, an upcoming hydrostatic test requirement of gas vessel 16, frequency of usage of gas vessel 16, a utilization of gas vessel 16, justification for additional equipment related to gas vessel 16, charge station 12, and/or system 10, a location of gas vessel 16, a filling date of gas vessel 16, an identification of system 10, a location of system 10, a current date, a current time, ambient air sample data, and an identification of an operator.

In one or more embodiments, data collection system 20 includes one or more processors 54 operatively connected to memory 52, RFID readers 22 and/or 24, and/or any component of control system 28. In one or more embodiments, processor 54 receives data from memory 52, memory 38, another component of control system 28, and/or from RFID readers 22 and/or 24. The data received from memory 52, memory 38, another component of control system 28, and/or RFID readers 22 and/or 24 may include, but is not limited to, data read from RFID tag 46 by RFID readers 22 and/or 24, data related to the gas vessel 16, data related to the gas vessel filling system 10 (including data relating to charge station 12), and/or the like. In one or more embodiments, processor 54 performs various decisions and/or performs various actions based on the data received from memory 52, memory 38, another component of the control system 28, and/or the RFID readers 22 and/or 24. For example, in one or more embodiments, processor 54 automatically controls some or all portions of the filling process, such as, but not limited to, activating the filling process, deactivating the filling process, selecting parameters of the filling process (such as, but not limited to, selecting a pressure to fill gas vessel 16 with and/or the like), and/or the like. Exemplary decisions and/or actions of processor 54 are described below with respect to FIGS. 4-5. Processor 54 is not limited to performing the decisions and/or actions illustrated in FIGS. 4-5 and is configured to perform other decisions/actions described herein.

In one or more embodiments, processor 54 transmits data to storage system 56 that is not a component of charge station 12. For example, processor 54 transmits data to memory 58 of storage system 56. Processor 54 transmits data read from RFID tag 46 by RFID readers 22 and/or 24, data related to gas vessel 16, data related to gas vessel filling system 10 (including data related to charge station 12), and/or the like. In one or more embodiments, processor 54 transmits the data using any suitable means, such as, but not limited to, using a wireless data transmitter 60 of data collection system 20 and/or using cable 62 of data collection system 20, i.e., data logging system. In one or more embodiments, processor 54 writes data to memory 52, memory 38, memory 58, and/or RFID tag 46. In one or more embodiments, processor 54 writes data read from RFID tag 46 by RFID readers 22 and/or 24, data related to gas vessel 16, data related to gas vessel filling system 10 (including data related to charge station 12), and/or the like. Moreover, in one or more embodiments, RFID readers 22 and/or 24 each write data to memory 52, memory 38, memory 58, and/or RFID tag 46. In one or more embodiments, RFID readers 22 and/or 24 each write data read from RFID tag 46 by RFID readers 22 and/or 24, data related to the gas vessel 16, data related to gas vessel filling system 10 (including data related to charge station 12), and/or the like.

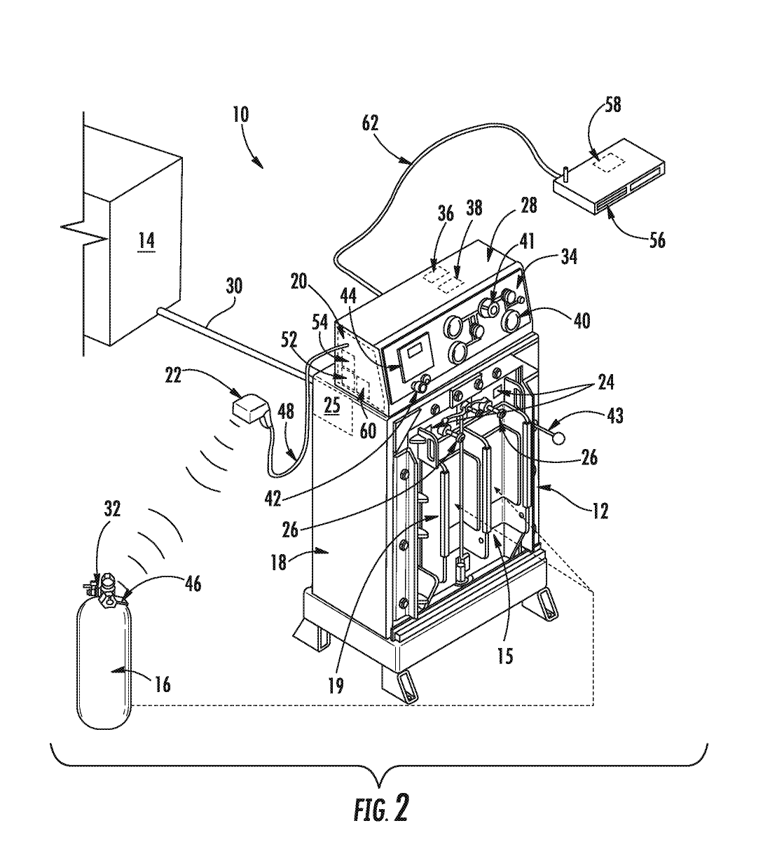

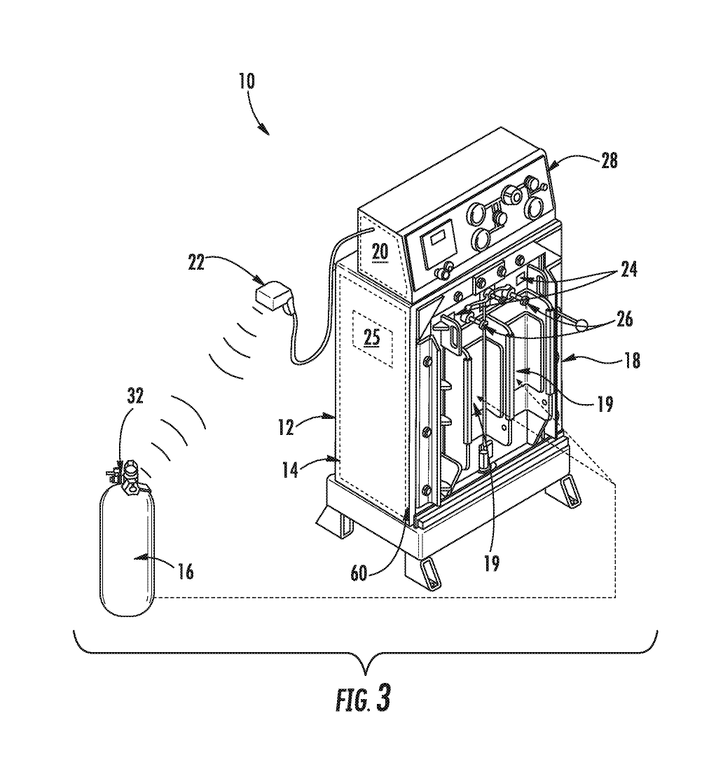

FIG. 2 is a perspective view of the gas vessel filling system 10 of FIG. 1. FIG. 3 is a perspective view of an exemplary alternative embodiment of gas vessel filling system 10. System 10 includes charge station 12 and gas supply 14. Charge station 12 includes housing 18, data collection system 20, one or more radio frequency identification (RFID) readers 22, one or more RFID readers 24, one or more vessel docks 19, one or more gas input ports 25, one or more gas output ports 26, and control system 28, as described with respect to FIG. 1. Gas supply 14 is a component of charge station 12. For example, in the exemplary embodiment, gas supply 14 is held within internal compartment 60 of charge station housing 18. Each gas input gas port 25 is fluidly connected to gas supply 14. Each gas output port 26 is configured to be fluidly connected to input port 32 of gas vessel 16 for filling gas vessel 16 with gas from gas supply 14. One or more input gas ports 25 being fluidly connected to one or more output gas ports 26.

FIG. 4 is a flowchart of the gas flow process performed by gas flow code 37 for filling the gas vessel 16 with gas using gas vessel filling system 10 in accordance with the principles of the invention. An empty or partially filled gas vessel 16 is loaded into a vessel dock 19 of the charge station 12. In one or more embodiments, loading gas vessel 16 into vessel dock 19 includes orienting the RFID tag 46 such that RFID tag information/data can be read by RFID reader 22 and/or 24. For example, when multiple output ports 26 are in use, the range of each antenna for RFID reader 24 can be set so that only a gas vessel 16 associated with a corresponding output port 26 can be interrogated and read. Charge station 12 causes RFID reader 22 and/or RFID reader 24 to read data from RFID tag 46 (Block S100). Charge station 12 receives data read from RFID reader 22 and/or 24 (Block S102). In one or more embodiments, data collection system 20 receives the data read from RFID reader 22 and/or 24. In one or more embodiments, the RFID data/information that is read from RFID tag 46 is used to determine one or more gas vessel characteristics and/or one or more filling criterion, as described herein.

Charge station 12, e.g., processor 54, determines whether an end of life date of gas vessel 16, e.g., a gas vessel characteristic, has expired (Block S104). In particular, charge station 12 determines whether at least one filling criterion such a time remaining to a predefined end of life date of gas vessel 16 is met. In one or more embodiments, the end of life date is included in the RFID data received from RFID reader 22 and/or 24, where the end of life date corresponds to a predefined date. In one or more embodiments, the end of life date of gas vessel 16 is determined based on received RFID data such by searching in memory 52 and/or requesting the hydrostatic test date, using the received RFID data. If the end of life date of gas vessel 16 has expired, charge station 12, e.g., processor 54, causes the display (on the display 44 or a display, not shown, of the system 10) of at least one of: a warning that the end of life date has expired, a warning that gas vessel 16 should not be filled by charge station 12, a warning that gas vessel 16 should be removed from service, among other warnings displayable by charge station 12 (Block S106). Charge station 12, e.g., processor 54 and/or 36, prevents gas vessel 16 from being filled with gas by the charge station 12, and/or the like (Block S108). In one or more embodiments, Block S108 is omitted or not performed after Block S106.

If charge station 12 has determined that the end of life date of gas vessel 16 has not expired, charge station 12, e.g., processor 54, determines whether a hydrostatic test date of gas vessel 16, e.g., a gas vessel characteristics, has expired (Block S110). In particular, charge station 12 determines whether at least one filling criterion such as time from a previous hydrostatic test date of gas vessel 16 is met. In one or more embodiments, the hydrostatic test date of gas vessel 16 is included in RFID data received from RFID reader. In one or more embodiments, the hydrostatic test date of gas vessel 16 is determined based on received RFID data such as by searching in memory 52 and/or requesting the hydrostatic test date, using the received RFID data. If the hydrostatic test date of gas vessel 16 has expired, charge station 12, e.g., processor 54, displays at least one of a warning that the cylinder hydrostatic test date has expired, a warning that gas vessel 16 should not be filled by charge station 12, a warning that the gas vessel 16 should be removed from service, among other warning that are displaying by charge station 12 (Block S106). Charge station 12, e.g., processor 54, prevents gas vessel 16 from being filled with gas by charge station 12, and/or the like (Block S108). In one or more embodiments, Block S108 is omitted or not performed after Block S106.

If the hydrostatic test date of gas vessel 16 has not expired, charge station 12, e.g., processor 54, determines if an operating pressure of gas vessel 16, e.g., a gas vessel characteristics, equals a fill pressure setting of charge station 12 (Block S112). In particular, charge station 12 determines whether at least one filling criterion such as the operating pressure of gas vessel 16 equaling or substantially equally a fill pressure of charge station 12 is met. If the operating pressure of gas vessel 16 does not equal the fill pressure setting of charge station 12, charge station 12, e.g., processor 54, causes the display of at least one of a warning that the operating pressure of gas vessel 16 does not equal the fill pressure setting of charge station 12, a warning that gas vessel 16 should not be filled by charge station 12, an indication that the fill pressure setting of charge station 12 should be changed, and/or the like (Block S114). In one or more embodiments, charge station 12, e.g., processor 54, at least temporarily prevents gas vessel 16 from being filled with gas by charge station 12.

Charge station 12 determines whether the fill pressure setting of charge station 12 have been changed to equal the operating pressure of gas vessel 16 (Block S116). In one or more embodiments, an operator manually changes the fill pressure setting of charge station 12 to equal the operating pressure of the gas cylinder 16. In one or more embodiments, in addition or alternative to the manual change of the fill pressure, if the operating pressure of gas vessel 16 does not equal the fill pressure setting of charge station 12, charge station 12, e.g., processor 54, automatically changes/adjusts the fill pressure setting of charge station 12 to equal the operating pressure of gas vessel 16.

If the determination is made by charge station 12 that the fill pressure setting is not changed, charge station 12 displaying at least one warning as described above (Block S106). In one or more embodiments, charge station 12, e.g., processor 54, prevents gas vessel 16 from being filled with gas by charge station 12, and/or the like (Block S108). In one or more embodiments, Block S108 is omitted or not performed after Block S106. Referring back to Block S116, if charge station 12 determines the fill pressure has been changed to equal the operating pressure of gas vessel 16, charge station 12, e.g., processor 54, causes the display of an indication that an operator can manually activate charge station 12 to fill vessel cylinder 16 with gas (Block S118). In alternative embodiment to manual activation of charge station 12, charge station 12, e.g., processor 54, automatically activates or initiates charge station 12 to fill gas vessel 16 with gas (Block S120).

At the initiation, during and/or at the end of the gas flow process, if the determination of the presence of contaminants based on one or more real time samples and analysis of the sample(s) is negative, the fill process continues. However, if the determination, by charge station 12 based one or more real time samples and analysis of the sample(s), is made that the presence of contaminants is positive and/or above a predefined threshold, charge station 12, e.g., processor 54, causes the display of a warning that gas vessel 16 should be removed from service. In addition to displaying the warning, charge station 12 prevents the gas cylinder 16 from being filled with gas by charge station 12, and/or the like. Additionally, data is stored/logged memory 52 and/or 38 referencing the specific gas vessel 16 and/or other date related to the gas flow process.

Charge station 12, e.g., processor 54 and/or RFID readers 22 and/or 24, write to memory 52, memory 38, memory 58, and/or to RFID tag 46, at least one of data read from RFID tag 46 by RFID readers 22 and/or 24, data related to gas vessel 16, data related to gas vessel filling system 10 (including data related to charge station 12), date related to the gas flow process, and/or the like (Block S122). Charge station 12, e.g., processor 54, transmits to storage system 56 at least one of data read from RFID tag 46 by RFID readers 22 and/or 14, data related to gas vessel 16, data related to gas vessel filling system 10 (including data related to charge station 12), date related to the gas flow process, and/or the like (Block S124).

After filling gas vessel 16, the data read from RFID tag 46 by RFID readers 22 and/or 24, the data related to gas vessel 16, the data related to the gas vessel filling system 10 (including data related to charge station 12), date related to the gas flow process, and/or the like can be used to track and/or manage a plurality of gas vessels 16. Uses of data may include, but are not limited to: early warning of upcoming cylinder obsolescence, upcoming hydrostatic test requirements, frequency of usage, equipment utilization, justification for additional equipment, tracking of cylinder locations, manage other fire department assets (such as, but not limited to, thermal imaging cameras, SCBA components, regulators, masks, pressure reducers, and/or the like), and/or the like.

FIG. 5 is a flowchart of an alternative embodiment of gas flow process of gas flow code 37 for filling the gas vessel 16 with gas using gas vessel filling system 10 in accordance with the principles of the invention. Gas input port 25 is removably connected to gas supply 14 and gas output port 26 is removably connected to the gas vessel, as described herein. Charge station 12, e.g., processor 36 and/or processor 54, causes a radio frequency identification (RFID) reader to interrogate an RFID tag associated with the gas vessel for RFID information/data (Block S126). Charge station 12 determines at least one gas vessel characteristic associated with the RFID information, as described herein (Block S127). In one or more embodiments, the at least one gas vessel characteristic includes at least one of a serial number of the gas vessel, operating pressure of the gas vessel, hydrostatic test date of the gas vessel, manufactured date of the gas vessel, type of gas vessel, frequency of usage of the gas vessel and a gas composition. In one or more embodiments, the at least one gas vessel characteristic includes a composition, i.e., chemical, of gas that the gas vessel is allowed to accept, e.g., fill gas. In one or more embodiments, at least one gas vessel characteristic includes a composition of gas the gas vessel is not allowed to accept, e.g., containment(s).

Charge station 12 controls a flow of gas from gas input port 25 to gas output port 26 based at least in part on the at least one gas vessel characteristic, as described herein (Block S128). For example, charge station 12 initiates, starts or restarts gas flow from gas input port 25 to gas output port 26 in order to fill gas vessel 16. Charge station 12 determines at least one filling criterion based at least in part on the RFID information, as described herein (Block S130). In one or more embodiments, the at least one filling criterion includes a threshold value for at least one fluid particulate. In one or more embodiments, the at least one filling criterion includes at least one of: time remaining to a predefined end life date of the gas vessel, time from a previous hydrostatic test date of the gas vessel, and a predefined number of refills of the gas vessel. In one or more embodiments, the at least one filling criterion includes whether an operating pressure level of the gas vessel equals a fill pressure level of the apparatus.

Charge station 12 determines whether the at least one filling criterion is met, as described herein (Block S132). For example, in one or more embodiments, charge station 12 performs at least one sample of the gas at gas output port 26 and/or gas input port 25 in which the determination of the at least one filling criterion is met including whether the at least one sample meets the at least one filling criterion. In one or more embodiments, the at least one sample is performed, i.e., taken, during the filling of the gas vessel such as to allow for real time analysis of the gas flow process. In one or more embodiments, the analysis of the one or more samples of gas are performed using well known methods in the art. In one or more embodiments, the at least one sample includes a sample of the gas contained in the gas vessel.

Change station 12 triggers at least one action if the at least one filling criterion is not met, as described herein (Block S134). In one or more embodiments, the at least one action that is triggered if the at least one sample does not meet the at least one filling criteria, includes: pausing the flow of gas from gas input port 25 to gas output port 26, and causing the RFID reader to write data to the RFID tag of the gas vessel. The data written to the RFID tag indicating the at least one filling criterion is not met. In one or more embodiments, the at least one action that is triggered includes: preventing the flow of gas from gas input port 25 to gas output port 26, and causing the RFID reader to write data to the RFID tag of the gas vessel, the data written to the RFID tag indicating the at least one filling criterion is not met. In one or more embodiments, at least one action includes generating at least one of an audio and visual alert.

In one or more embodiments, charge station 12, is further configured to determine a first pressure of gas vessel before initiating flow of gas from gas input port 25 to gas output port 26, determine a second pressure of the gas vessel after the flow of gas from gas input port 25 to gas output port 26 has been stopped, and cause the RFID reader to write the first pressure and the second pressure of the gas vessel to the RFID tag. In one or more embodiments, at least one action is triggered if the at least one filling criterion is met.

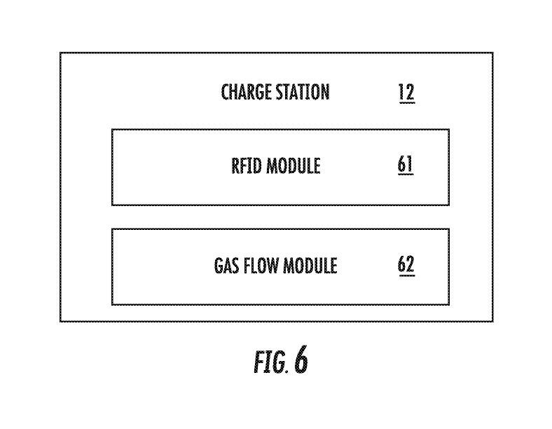

FIG. 6 is a block diagram of an alternative embodiment of charge station 12 in accordance with the principles of the invention. Charge station 12 includes radio frequency identification (RFID) module 61 that is configured to perform the communication as described above with respect to RFID reader 22 and/or 24. Charge station 12 includes gas flow module 62 that is configured to perform the gas flow process describe herein such as with respect to FIGS. 4-5. In one or more embodiments, charge station 12 includes other modules for perform charge station 12 functions described herein.

One example embodiment is as follows:

Embodiment 1. A charge station for filling a gas cylinder with gas, said charge station having:

a gas output port configured to be fluidly connected to a supply of gas, the gas output port configured to be fluidly connected to the gas cylinder for filling the gas cylinder with gas from the supply of gas;

a control system operatively connected to the gas output such that the control system is configured to control filling of the gas cylinder; and

a radio frequency identification (RFID) reader operatively connected to the control system, the RFID reader configured to read data from an RFID tag on the gas cylinder.

The embodiments described and/or illustrated herein may provide a gas cylinder filling system that may be operated by an operator having less training as compared to at least some known gas cylinder filling systems. The embodiments described and/or illustrated herein provide a gas cylinder filling system that may reduce a number of operator errors as compared to at least some known gas cylinder filling systems.

In some embodiments, data collection system 20 may be a component of control system 28. Moreover, any functions, method steps, decisions, actions, and/or the like of the processor 54 and the data collection system 20 may be additionally or alternatively performed by the control system 20 or other part/process/component of charge station 12.

The subject matter described and/or illustrated herein includes gas vessel filling system 10 that utilizes an RFID tag and reader to supply data from gas vessel 16 to data collection system 20 and/or a control system 28 for use filling gas vessels with gas.

Some Embodiments:

According to one aspect of the invention, an apparatus 12, i.e., charge station 12, for transferring gas to a gas vessel 16 is provided. The apparatus 12 includes a radio frequency identification (RFID) reader 22, 24 configured to interrogate an RFID tag 46 associated with the gas vessel 16 for RFID information. The apparatus 12 includes a gas input port 25 configured to be in removably connected to gas supply 14, a gas output port 26 configured to be removably connected to the gas vessel 16 and a processor 54 configured to: determine at least one gas vessel characteristic associated with the RFID information, control a flow of gas from the gas input port 25 to the gas output port 26 based at least in part on the at least one gas vessel characteristic, determine at least one filling criterion based at least in part on the RFID information, determine whether the at least one filling criterion is met, and trigger at least one action if the at least one filling criterion is not met.

According to one embodiment of this aspect, the processor 54 is configured to perform at least one sample of the gas at the gas output port 26. The determination whether the at least one filling criterion is met includes determining whether the at least one sample meets the at least one filling criterion.

According to one embodiment of this aspect, the at least one gas vessel characteristic includes at least one of a serial number of the gas vessel 16, operating pressure of the gas vessel 16, hydrostatic test date of the gas vessel 16, manufactured date of the gas vessel 14, type of gas vessel 16, frequency of usage of the gas vessel 16 and a gas composition. According to one embodiment of this aspect, the at least one gas vessel characteristic includes a composition of gas that the gas vessel 16 is allowed to accept. According to one embodiment of this aspect, the at least one gas vessel characteristic includes a composition of gas the gas vessel 16 is not allowed to accept. According to one embodiment of this aspect, the at least one filling criterion includes a threshold value for at least one particulate. The at least one action that is triggered if the at least one sample does not meet the at least one filling criteria, includes: at least temporarily stopping the flow of gas from the gas input port 25 to the gas output port 26, and causing the RFID reader 22, 24 to write data to the RFID tag 46 of the gas vessel 16, the data written to the RFID tag 46 indicating the at least one filling criterion is not met.

According to one embodiment of this aspect, the at least one sample is performed during the filling of the gas vessel 16. According to one embodiment of this aspect, the at least one sample includes a sample of the gas contained in the gas vessel 16. According to one embodiment of this aspect, the at least one filling criterion includes at least one of: time remaining to a predefined end life date of the gas vessel 16, time from a previous hydrostatic test date of the gas vessel 16 and a predefined number of refills of the gas vessel 16. The at least one action that is triggered includes: preventing the flow of gas from the gas input port to the gas output port, and causing the RFID reader 22, 24 to write data to the RFID tag 46 of the gas vessel 16, the data written to the RFID tag 46 indicating the at least one filling criterion is not met.

According to one embodiment of this aspect, the processor 54 is further configured to: determine a first pressure of gas vessel 16 before initiating flow of gas from the gas input port 25 to the gas output port 26, determine a second pressure of the gas vessel 26 after the flow of gas from the gas input port 25 to the gas output port 26 has been stopped, and cause the RFID reader 22, 24 to write the first pressure and the second pressure of the gas vessel 16 to the RFID tag 46. According to one embodiment of this aspect, the at least one action includes generating at least one of an audio and visual alert. According to one embodiment of this aspect, the at least one filling criterion includes whether an operating pressure level of the gas vessel 16 equals a fill pressure level of the apparatus 12. The at least one action that is triggered includes triggering at least one of an audio warning and visual warning.

According to another aspect of the invention, a method for an apparatus 12 for transferring gas to a gas vessel 16 is provided. The apparatus 12 includes a gas input port 25 configured to be removably connected to a gas supply 14, and a gas output port 26 configured to be removably connected to the gas vessel 14. An RFID tag 46 associated with the gas vessel 14 is interrogated for RFID information (Block S126). At least one gas vessel characteristic associated with the RFID information is determined (Block S127). A flow of gas from the gas input port 25 to the gas output port 26 is controlled based at least in part on the at least one gas vessel characteristic (Block S128). At least one filling criterion is determined based at least in part on the RFID information (Block S130). A determination is made whether the at least one filling criterion is met (Block S132). At least one action is triggered if the at least one filling criterion is not met (Block S134).

According to one embodiment of this aspect, at least one sample of the gas is performed at the gas output port 26. The determination whether the at least one filling criterion is met includes determining whether the at least one sample meets the at least one filling criterion. According to one embodiment of this aspect, the at least one gas vessel characteristic includes at least one of a serial number of the gas vessel 14, operating pressure of the gas vessel 14, hydrostatic test date of the gas vessel 14, manufactured date of the gas vessel 14, type of gas vessel 14, frequency of usage of the gas vessel 14 and a gas composition. According to one embodiment of this aspect, the at least one gas vessel characteristic includes a composition of gas that the gas vessel 14 is allowed to accept.

According to one embodiment of this aspect, the at least one gas vessel characteristic includes a composition of gas the gas vessel 14 is not allowed to accept. According to one embodiment of this aspect, the at one filling criterion includes a threshold value for at least one particulate. The at least one action that is triggered if the at least one sample does not meet the at least one filling criteria, includes: pausing the flow of gas from the gas input port 25 to the gas output port 26, and causing the RFID reader 22, 24 to write data to the RFID tag 46 of the gas vessel 14, the data written to the RFID tag 46 indicating the at least one filling criterion is not met.

According to one embodiment of this aspect, the at least one sample is performed during the filling of the gas vessel 14. According to one embodiment of this aspect, the at least one sample includes a sample of the gas contained in the gas vessel 14. According to one embodiment of this aspect, the at least one filling criterion includes at least one of: time remaining to a predefined end life date of the gas vessel 14, time from a previous hydrostatic test date of the gas vessel 14, and a predefined number of refills of the gas vessel 14. The at least one action that is triggered includes: preventing the flow of gas from the gas input port 25 to the gas output port 26, and causing the RFID reader 22, 24 to write data to the RFID tag 46 of the gas vessel 14, the data written to the RFID tag 46 indicating the at least one filling criterion is not met.

According to one embodiment of this aspect, a first pressure of gas vessel 14 is determined before initiating flow of gas from the gas input port 25 to the gas output port 26. A second pressure of the gas vessel 14 is determined after the flow of gas from the gas input port 25 to the gas output port 26 has been stopped. The RFID reader 22, 24 is caused to write the first pressure and the second pressure of the gas vessel 14 to the RFID tag 46. According to one embodiment of this aspect, the at least one action includes generating at least one of an audio and visual alert. According to one embodiment of this aspect, the at least one filling criterion includes whether an operating pressure level of the gas vessel 14 equaling a fill pressure level of the apparatus 12. The at least one action that is triggered includes triggering at least one of an audio warning and visual warning.

According to another aspect of the invention, an apparatus for transferring gas to a gas vessel 16 is provided. The apparatus 12 includes a radio frequency identification (RFID) module configured to cause interrogation of an RFID tag 46 associated with the gas vessel 16 for RFID information. The apparatus 12 includes a gas input port 25 configured to be in removably connected to a gas supply 14. The apparatus 12 includes a gas output port 26 configured to be removably connected to the gas vessel 14. The apparatus 12 includes a processor 54 configured to: determine at least one gas vessel characteristic associated with the RFID information, control a flow of gas from the gas input port 25 to the gas output port 26 based at least in part on the at least one gas vessel characteristic, determine at least one filling criterion based at least in part on the RFID information, determine whether the at least one filling criterion is met, and trigger at least one action if the at least one filling criterion is not met.

In one embodiment, a charge station 12 is provided for filling a gas cylinder 16 with gas. The charge station 12 includes a gas output port 26 configured to be fluidly connected to a supply of gas 14. The gas output port 26 is configured to be fluidly connected to the gas cylinder for filling the gas cylinder 16 with gas from the supply of gas 14. The charge station 12 also includes a control system 28 operatively connected to the gas output 26 such that the control system 28 is configured to control filling of the gas cylinder 16, and a radio frequency identification RFID reader 22, 24 operatively connected to the control system 28, the RFID reader 22, 24 configured to read data from an RFID tag 46 on the gas cylinder 16.

In another embodiment, a gas cylinder filling system 10 is provided for filling a gas cylinder 16 with gas. The gas cylinder filling system 10 includes a supply of gas 14 and a charge station 12. The charge station 12 includes a gas output port 26 fluidly connected to the supply of gas. The gas output port 26 is configured to be fluidly connected to the gas cylinder 16 for filling the gas cylinder 16 with gas from the supply of gas 14. The charge station 12 also includes a control system 28 operatively connected to the gas output 26 such that the control system 28 is configured to control filling of the gas cylinder 16, and a radio frequency identification (RFID) reader 22, 24 operatively connected to the control system 28, the RFID reader 22, 24 configured to read data from an RFID tag 46 on the gas cylinder 16.

In another embodiment, a method is provided for filling a gas cylinder 16 with gas using a charge station 12. The method includes reading data from a radio frequency identification (RFID) tag 46 on the gas cylinder 16, and filling the gas cylinder 16 with gas based at least in part on data read from the RFID tag 46 on the gas cylinder 16.

Exemplary embodiments are described and/or illustrated herein in detail. The embodiments are not limited to the specific embodiments described herein, but rather, components and/or steps of each embodiment may be utilized independently and separately from other components and/or steps described herein. Each component, and/or each step of one embodiment, can also be used in combination with other components and/or steps of other embodiments. When introducing elements/components/etc. described and/or illustrated herein, the articles “a”, “an”, “the”, “said”, and “at least one” are intended to mean that there are one or more of the element(s)/component(s)/etc. The terms “comprising”, “including” and “having” are intended to be inclusive and mean that there may be additional element(s)/component(s)/etc. other than the listed element(s)/component(s)/etc. Moreover, the terms “first,” “second,” and “third,” etc. in the claims are used merely as labels, and are not intended to impose numerical requirements on their objects. Dimensions, types of materials, orientations of the various components, and the number and positions of the various components described and/or illustrated herein are intended to define parameters of certain embodiments, and are by no means limiting and are merely exemplary embodiments. Many other embodiments and modifications within the spirit and scope of the claims will be apparent to those of skill in the art upon reviewing the description and illustrations. The scope of the subject matter described and/or illustrated herein should therefore be determined with reference to the appended claims, along with the full scope of equivalents to which such claims are entitled. Further, the limitations of the following claims are not written in means-plus-function format and are not intended to be interpreted based on 35 U.S.C. § 112, sixth paragraph, unless and until such claim limitations expressly use the phrase “means for” followed by a statement of function void of further structure.

While the subject matter described and/or illustrated herein has been described and/or illustrated in terms of various specific embodiments, those skilled in the art will recognize that the subject matter described and/or illustrated herein can be practiced with modification within the spirit and scope of the claims.

As will be appreciated by one of skill in the art, the concepts described herein may be embodied as a method, data processing system, and/or computer program product. Accordingly, the concepts described herein may take the form of an entirely hardware embodiment, an entirely software embodiment or an embodiment combining software and hardware aspects all generally referred to herein as a “circuit” or “module.” Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object-oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. An apparatus for transferring gas to a gas vessel, the apparatus comprising:
a radio frequency identification (RFID) reader configured to interrogate an RFID tag associated with the gas vessel for RFID information;
a gas input port configured to be in removably connected to gas supply; a gas output port configured to be removably connected to the gas vessel;
a processor configured to:
determine at least one gas vessel characteristic associated with the RFID information;
control a flow of gas from the gas input port to the gas output port based at least in part on the at least one gas vessel characteristic;
determine at least one filling criterion based at least in part on the RFID information;
determine whether the at least one filling criterion is met;
trigger at least one action if the at least one filling criterion is not met.

2. The apparatus of claim 1, wherein the processor is further configured to perform at least one sample of the gas at the gas output port; and
the determination of whether the at least one filling criterion is met includes determining whether the at least one sample meets the at least one filling criterion.

3. The apparatus of claim 1, wherein the at least one gas vessel characteristic includes at least one of a serial number of the gas vessel, operating pressure of the gas vessel, hydrostatic test date of the gas vessel, manufactured date of the gas vessel, type of gas vessel, frequency of usage of the gas vessel and a gas composition.

4. The apparatus of claim 1, wherein the at least one gas vessel characteristic includes a composition of gas that the gas vessel is allowed to accept.

5. The apparatus of claim 1, wherein the at least one gas vessel characteristic includes a composition of gas the gas vessel is not allowed to accept.

6. The apparatus of claim 1, wherein the at one filling criterion includes a threshold value for at least one particulate; and
the at least one action that is triggered if the at least one sample does not meet the at least one filling criteria, includes:
at least temporarily stopping the flow of gas from the gas input port to the gas output port; and
causing the RFID reader to write data to the RFID tag of the gas vessel, the data written to the RFID tag indicating the at least one filling criterion is not met.

7. The apparatus of claim 6, wherein the at least one sample is performed during the filling of the gas vessel.

8. The apparatus of claim 6, wherein the at least one sample includes a sample of the gas contained in the gas vessel.

9. The apparatus of claim 1, wherein the at least one filling criterion includes at least one of:
time remaining to a predefined end life date of the gas vessel;
time from a previous hydrostatic test date of the gas vessel; and
a predefined number of refills of the gas vessel; and
the at least one action that is triggered includes:
preventing the flow of gas from the gas input port to the gas output port; and
causing the RFID reader to write data to the RFID tag of the gas vessel, the data written to the RFID tag indicating the at least one filling criterion is not met.

10. The apparatus of claim 1, wherein the processor is further configured to:
determine a first pressure of gas vessel before initiating flow of gas from the gas input port to the gas output port;
determine a second pressure of the gas vessel after the flow of gas from the gas input port to the gas output port has been stopped; and
cause the RFID reader to write the first pressure and the second pressure of the gas vessel to the RFID tag.

11. The apparatus of claim 1, wherein the at least one action includes generating at least one of an audio and visual alert.

12. The apparatus of claim 1, wherein the at least one filling criterion includes whether an operating pressure level of the gas vessel equals a fill pressure level of the apparatus;
the at least one action that is triggered includes triggering at least one of an audio warning and visual warning.

13. A method for an apparatus for transferring gas to a gas vessel, the apparatus including a gas input port configured to be removably connected to a gas supply, the apparatus including a gas output port configured to be removably connected to the gas vessel, the method comprising:
interrogating an RFID tag associated with the gas vessel for RFID information;
determining at least one gas vessel characteristic associated with the RFID information;
controlling a flow of gas from the gas input port to the gas output port based at least in part on the at least one gas vessel characteristic;
determining at least one filling criterion based at least in part on the RFID information;
determining whether the at least one filling criterion is met;
triggering at least one action if the at least one filling criterion is not met.

14. The method of claim 13, further comprising performing at least one sample of the gas at the gas output port; and
the determination whether the at least one filling criterion is met includes determining whether the at least one sample meets the at least one filling criterion.

15. The method of claim 13, wherein the at least one gas vessel characteristic includes at least one of a serial number of the gas vessel, operating pressure of the gas vessel, hydrostatic test date of the gas vessel, manufactured date of the gas vessel, type of gas vessel, frequency of usage of the gas vessel and a gas composition.

16. The method of claim 13, wherein the at least one gas vessel characteristic includes a composition of gas that the gas vessel is allowed to accept.

17. The method of claim 13, wherein the at least one gas vessel characteristic includes a composition of gas the gas vessel is not allowed to accept.

18. The method of claim 13, wherein the at one filling criterion includes a threshold value for at least one particulate; and
the at least one action that is triggered if the at least one sample does not meet the at least one filling criteria, includes:
pausing the flow of gas from the gas input port to the gas output port; and
causing the RFID reader to write data to the RFID tag of the gas vessel, the data written to the RFID tag indicating the at least one filling criterion is not met.

19. The method of claim 18, wherein the at least one sample is performed during the filling of the gas vessel.

20. The method of claim 18, wherein the at least one sample includes a sample of the gas contained in the gas vessel.

21. The method of claim 13, wherein the at least one filling criterion includes at least one of:
time remaining to a predefined end life date of the gas vessel;
time from a previous hydrostatic test date of the gas vessel; and
a predefined number of refills of the gas vessel; and
the at least one action that is triggered includes:
preventing the flow of gas from the gas input port to the gas output port; and
causing the RFID reader to write data to the RFID tag of the gas vessel, the data written to the RFID tag indicating the at least one filling criterion is not met.

22. The method of claim 13, further comprising:
determining a first pressure of gas vessel before initiating flow of gas from the gas input port to the gas output port;
determining a second pressure of the gas vessel after the flow of gas from the first gas port to the gas output port has been stopped; and
causing the RFID reader to write the first pressure and the second pressure of the gas vessel to the RFID tag.

23. The method of claim 13, wherein the at least one action includes generating at least one of an audio and visual alert.

24. The method of claim 13, wherein the at least one filling criterion includes whether an operating pressure level of the gas vessel equaling a fill pressure level of the apparatus;
the at least one action that is triggered includes triggering at least one of an audio warning and visual warning.

25. An apparatus for transferring gas to a gas vessel, the apparatus comprising:
a radio frequency identification (RFID) module configured to cause interrogation of an RFID tag associated with the gas vessel for RFID information;
a gas input port configured to be in removably connected to a gas supply;
a gas output port configured to be removably connected to the gas vessel;
a gas flow module configured to:
determine at least one gas vessel characteristic associated with the RFID information;
control a flow of gas from the gas input port to the gas output port based at least in part on the at least one gas vessel characteristic;
determine at least one filling criterion based at least in part on the RFID information;
determine whether the at least one filling criterion is met;
trigger at least one action if the at least one filling criterion is not met.
